(19) United States
(12) Patent Application Publication
(10) Pub. No.: US 2026/0116297 A1
(43) Pub. Date: Apr. 30, 2026

(54) EXTERIOR REARVIEW MIRROR ASSEMBLY AND VEHICLE

(71) Applicant: Motherson Innovations Company Limited, London (GB)

(72) Inventors: Attila KANTOR, Stuttgart (DE); Istvan SZMOLENSZKI, Stuttgart (DE); Volker ERHART, Stuttgart (DE); Gergo KALMAR, Mosonszolnok (HU); Elemer VISKI-LATOR, Mosonszolnok (HU); Peter FOGARASI, Mosonszolnok (HU)

(21) Appl. No.: 19/366,671

(22) Filed: Oct. 23, 2025

(30) Foreign Application Priority Data
Oct. 29, 2024 (DE) 10 2024 131 583.0

(51) Int. Cl. B60R 1/072; B60R 1/12

(52) U.S. Cl. CPC B60R 1/072; B60R 1/12; B60R 2001/1253

(57) ABSTRACT

The present disclosure relates to an exterior rearview mirror assembly for a vehicle, the exterior rearview mirror assembly comprising at least one housing; at least one rotatable member rotatably connected at least indirectly to the housing, wherein the rotatable member is configured to mount at least one exterior rearview mirror and/or camera; at least one restriction element being arranged on the housing for restricting the rotatable member to a pre-determined rotation, where the restriction element is configured as a two component element comprising at least one stopper and at least one dampening member and where the dampening member is configured to engage with the rotatable member when contacting the restriction element. Further, the present disclosure relates to a vehicle with an exterior rearview mirror assembly.

### CROSS-REFERENCE TO RELATED APPLICATION

This application claims priority to German Patent Application No. DE 10 2024 131 583.0, filed on Oct. 29, 2024, the entirety of which is incorporated herein by reference.

### FIELD

The present disclosure relates to an exterior rearview mirror assembly. Further, the present disclosure is directed towards a vehicle with such an exterior rearview mirror assembly.

### BACKGROUND

In general, the existing exterior rearview mirror assembly comprises an exterior rearview mirror, housing, a rotatable member and a restriction element. The rotatable member enables automatic or manual folding and tilting of the exterior rearview mirror. The rotatable member involves multiple mechanisms to achieve the folding and tilting of the exterior rearview mirror.

Further, the housing is configured to mount the rotatable member, wherein the rotatable member is configured to mount the exterior rearview mirror. Further, the housing is configured to mount various electronic components such as cameras and/or sensors as well. Furthermore, the housing is configured to mount at least one restriction element such that the movement of the rotatable member may be restricted by the restriction element. The at least one restriction element acts as a physical barrier to restrict the movement of the rotatable member. However, the existing exterior rearview mirror assembly poseS a problem of noise and material failure when there is collision between the rotatable member and the restriction element.

DE 10 2018 218 499 B4 relates to an exterior rearview mirror assembly for a vehicle comprising: a mirror base including a mounting portion and a housing, wherein a mirror head is pivotally mounted to the mirror base and mounting portion. The mirror head is pivotable between a fold-down position and a drive position. To reduce unwanted noises during the pivot movement a specific sealing within a gap between the mirror head and the mirror base is proposed. The gap seal comprises an inner soft component that engages the mirror base and an outer soft component that engages the housing of the mirror base. When the fold-down drive pivots the mirror head between the fold-down position and the drive position, the mirror head slidably engages the hard component of the gap seal avoiding grinding or squeaking noises. No measures are proposed how to avoid or reduce unwanted noises or material failures when reaching the end positions in form of the fold-down position and the drive position. US 2008 204 912 A1 relates to an adjustable mirror, in particular to an outside mirror of a motor vehicle, with a hinge, which links a mirror support to a mirror base so that the mirror can be twisted about an axis of rotation. A biasing element in form of an elastomeric element is arranged between the mirror base and the mirror support and is form-fitted or bonded to the mirror support and/or to the mirror base and holds the mirror support in a first position. The elastomeric element biases a plastic coupling component into contact with recesses formed within a plastic component. when the mirror support is moved from a first position into a second position against the biasing force build up by the elastomeric element. No measures are proposed how to avoid or reduce unwanted noises or material failures when reaching the first position and the second position of the mirror support relative to the mirror base due to the contact of the coupling component with the recesses.

CN 20 998 7831 U relates to an outside rearview mirror device which comprises a base plate used for installing a lens, a rearview mirror, a front-view mirror, a rearview mirror, wherein the base plate is provided with a supporting hole, and a supporting shaft is arranged in the supporting hole, and the base plate is connected with a base in a rotating mode through the supporting shaft. The limiting rail groove extends in the axial direction and is formed in the base plate. The spring is arranged outside the supporting shaft in a sleeving mode and provided with a limiting component extending outwards in the radial direction. The limiting part is embedded into the limiting rail groove. In order to reduce or even eliminate noise that may occur due to friction between the limiting member and the inner wall of the limiting rail groove, at least one of the limiting member and the inner wall of the limiting rail groove is made of non-metal. Using the spring as a limiting member increase the probability of material failure. Further, it only reduces the noise of the spring but not of the joint connection of the mirror head.

DE 10 2017 104 755 B3 relates to a rearview arrangement for a motor vehicle, comprising a base which can be attached to the motor vehicle and a head which can be rotated relative thereto, wherein the head has at least one base body with a bearing opening for receiving a rotation axis connected to the base, wherein the base is formed jointly with a dome, and the dome has at least one first stop element which can be brought into engagement with at least one complementary second stop element of a union nut which can be screwed onto the dome, wherein the union nut provides a stop for a spring running around the dome, in particular in the form of a spiral spring.

In view of the aforementioned drawbacks and others inherent in the existing state of the art, there is a need to develop an exterior rearview mirror assembly for a vehicle which reduces noise production and material failure on collision of a rotatable member with a restriction element.

### SUMMARY

An object of the present disclosure is to further develop the known exterior rearview mirror assembly to at least partly overcome the known drawbacks of the prior art. In embodiments, it is an object to develop an exterior rearview mirror assembly for a vehicle which reduces noise production and material failure on collision of a rotatable member with a restriction element.

This object may be solved by an exterior rearview mirror assembly for a vehicle according to the embodiments described and claimed herein.

According to an embodiment, the exterior rearview mirror assembly may comprise a housing; a rotatable member rotatably mounted on the housing, wherein the rotatable member is configured to mount an exterior rearview mirror; a restriction element, in particular comprising a stopper, configured on the housing; and a dampening member configured to surround at least a portion of the stopper and optionally comprised by the restriction element, wherein the dampening member is configured to engage with the rotatable member for restricting the rotatable member to a pre-determined rotation.

In an embodiment, the present disclosure may also comprise a first plastic member, wherein the first plastic member is configured for covering a portion of the housing.

In an embodiment of the present disclosure, the dampening member may comprise a second plastic member and a third plastic member, wherein the second plastic member configured to surround the at least a portion of the stopper, and the third plastic member configured to sandwich between the stopper and the second plastic member.

In embodiments of the present disclosure, the stopper may be made up of a metal material, a hard plastic material, and/or an alloy material.

In embodiments of the present disclosure, the rotatable member may be made up of PAG50 material.

In an embodiment of the present disclosure, the first plastic member and the second plastic member may be made up of the same material.

In an embodiment of the present disclosure, the third plastic member may be softer than the first plastic member and the second plastic member.

In an embodiment of the present disclosure, the first plastic member and the second plastic member may form a unitary plastic body.

In an embodiment of the present disclosure, the first plastic member may be made up of PPGF30 material.

In an embodiment of the present disclosure, the third plastic member may be made up of TPE Shore A60 material.

In an embodiment of the present disclosure, the second plastic member may be an extended surface of the first plastic member.

In an embodiment of the present disclosure, the housing, the stopper, the first plastic member, the second plastic member and the third plastic member may be static and/or fixed members.

In an embodiment of the present disclosure, the third plastic member may extend along a portion of the first plastic member.

In an embodiment of the present disclosure, the rotatable member may comprise a protruding member, wherein the protruding member is configured to engage with the dampening member on the stopper.

Embodiments of the present disclosure also relate to a vehicle with an exterior rearview mirror assembly as described above.

According to various embodiments surrounding at least a portion of the stopper may include being attached at least partly directly or indirectly to the stopper. Surrounding may also include that two elements touch each other. In another embodiment surround may be understood as a total surrounding of the stopper. In another embodiment, the dampening member may surround the stopper from specific portion or surrounding is to be understood as being attached to at least a portion of one or more surfaces of the stopper.

According to an embodiment to sandwich an element between two parts is to be understood as being at least partly arranged between two parts, wherein the two parts are optionally located at least partly at opposite sides of the element.

The wording “fixed member” is to be understood as a member that is, optionally permanently, connected to another element in a manner not allowing a relative movement other than deformations, either flexible or permanent, with respect to the other element.

An advantage of embodiments of the present disclosure is improving noise reduction and durability by using a soft and elastic dampening member which absorbs the impact by moving, in particular rotating, parts of the exterior rearview mirror assembly.

### BRIEF DESCRIPTION OF THE DRAWINGS

Other aspects, advantages, and salient features of the present disclosure will become apparent to those skilled in the art from the following detailed description, which taken in conjunction with the annexed drawings, discloses exemplary embodiments of the disclosure, wherein:

FIG. 1 shows a perspective view of a vehicle with an exterior rearview mirror assembly in accordance with an embodiment of the present disclosure.

FIG. 2 shows a perspective view of an exterior rearview mirror assembly in accordance with an embodiment of the present disclosure.

FIG. 3 shows an enlarged view of parts of the exterior rearview mirror assembly of FIG. 2 with a housing, a rotatable member, a protruding member, a dampening member and a stopper.

FIG. 4 shows an enlarged view of parts of the exterior rearview mirror assembly of FIGS. 2 and 3 with the housing, the dampening member and the stopper mounted.

FIG. 5a shows an experimental noise-time curve for existing exterior rearview mirror assembly representing folding operation.

FIG. 5b shows an experimental noise-time curve for existing exterior rearview mirror assembly representing unfolding operation.

FIG. 6a shows an experimental noise-time curve for the exterior rearview mirror assembly in accordance with an embodiment of a present disclosure representing folding operation.

FIG. 6b shows an experimental noise-time curve for the exterior rearview mirror assembly in accordance with an embodiment of a present disclosure representing unfolding operation.

The drawings referred to in this description are not to be understood as being drawn to scale except if specifically noted, and such drawings are only exemplary in nature.

### DETAILED DESCRIPTION

The foregoing objects, features and advantages of the present disclosure will become more apparent from the following detailed description related to the accompanying drawings. However, various modifications may be applied to the present disclosure, and the present disclosure may have various embodiments of the present disclosure. Hereinafter, specific embodiments of the present disclosure, which are illustrated in the drawings, will be described in detail.

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

In the drawings, the thicknesses of layers and regions may be exaggerated for clarity. When it is indicated that an element or layer is “on” or “above” another element or layer, this comprises a case in which another layer or element is interposed therebetween as well as a case in which the element or layer is directly above the other element or layer. In principle, reference signs designate elements throughout the specification. In the following description, the same reference signs are used to designate elements, which have the same function within the same idea illustrated in the drawings of each embodiment of the present disclosure.

When detailed description of known functions or configurations related to the present disclosure is deemed to unnecessarily blur the gist of the disclosure, the detailed description thereof will be omitted. Also, numerals (e.g., first, second, etc.) used in the description herein are merely identifiers for distinguishing one element from another element.

In addition, the terms “module” and “unit” used to refer to elements in the following description are given or used in combination only in consideration of ease of writing the specification, and the terms themselves do not have distinct meanings or roles.

Furthermore, the use of a singular term, such as, “a” is not to be interpreted as limiting the number of components or details of particular components. Additionally, various terms and/or phrases describing or indicating a position or directional reference such as, but not limited to, “top”, “bottom”, “front”, “rear”, “forward”, “rearward”, “end”, “exterior”, “inner”, “left”, “right”, “vertical”, “horizontal”, etc. may relate to one or more particular components as seen generally from a user's vantage point during use or operation, and such terms and/or phrases are not to be interpreted as limiting, but merely as a representative basis for describing the disclosure to one skilled in the art. In addition, a suffix “region”, “part”, “unit” for a component used in the following description are given or mixed in consideration of only the ease of writing the specification, and do not have meanings or roles distinguished from each other.

While the present disclosure is illustrated in the context of a four-wheeled vehicle, however, holding structure and aspects and features thereof can be used with other types of vehicles such as a two-wheeled vehicle, three-wheeled vehicle, six-wheeled vehicle, eight-wheeled vehicle, etc. as well. In illustrated embodiments, it is to be noted that terms such as “four-wheeled vehicle” and “vehicle” are interchangeably used throughout the description.

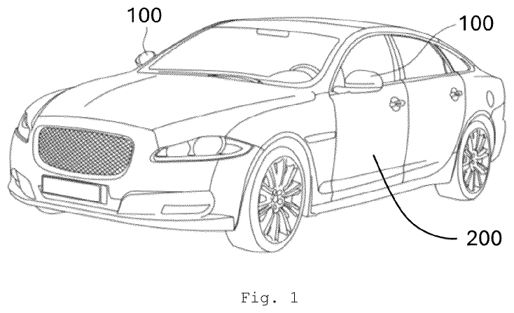

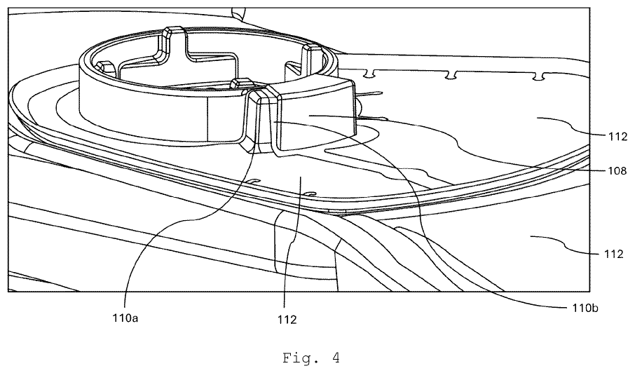

Various example embodiments of the present disclosure are described hereinafter with reference to FIG. 1 to FIGS. 6a-6b.

FIG. 1 shows a perspective view of a vehicle 200 in accordance with an embodiment of the present disclosure. The vehicle 200 referred to herein embodies a four-wheeled vehicle. Alternatively, the vehicle 200 may embody other vehicles, such as two-wheeled vehicles, three-wheeled vehicles, six-wheeled vehicles, eight-wheeled vehicles, all-terrain vehicles (ATVs), etc., without limiting the scope of the disclosure. FIG. 1 also shows an exterior rearview mirror assembly 100 configured on the vehicle 200. The exterior rearview mirror assembly 100 may be configured on any side of the vehicle 200 for assistance in driving of the vehicle 200.

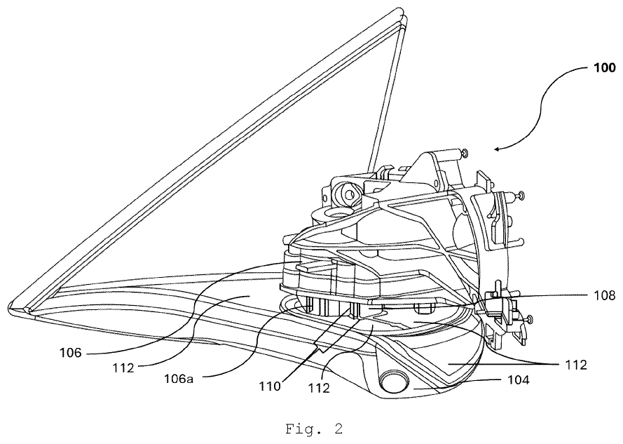

FIG. 2 shows a perspective view of the exterior rearview mirror assembly 100. The exterior rearview mirror assembly 100 encompasses a housing 104, a rotatable member 106, a restriction element comprising a stopper 108 and a dampening member 110, and a first plastic member 112.

Further, as shown in FIGS. 2-4, the housing 104 may be configured for mounting the rotatable member 106 and the stopper 108. The housing 104 may be made up of conventionally known material in the industry. The housing 104 may also be configured to plurality of actuators and drive trains for different functions. Further, at least a portion of the housing 104 may be covered by the first plastic member 112.

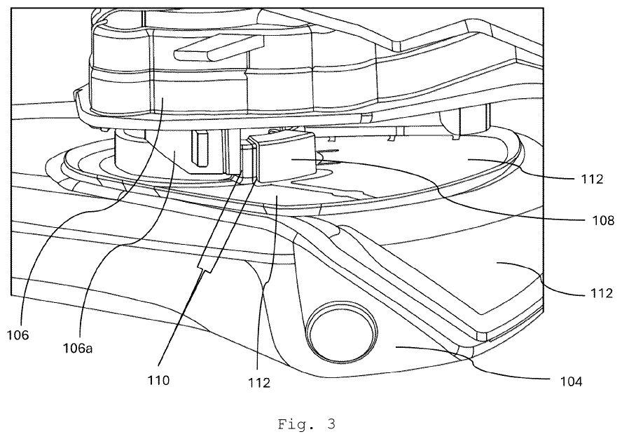

The rotatable member 106 and the stopper 108 may be mounted on the housing 104. In another embodiment, the rotatable member 106 and the stopper 108 may protrude through the first plastic member 112. The first plastic member 112 may be made up of, but not limited to, PA-GF30 material. The rotatable member 106 may be configured to rotate on the housing 104. Further, the rotatable member 106 may be configured to mount an exterior rearview mirror. The rotatable member 106 may be configured to rotate on the housing 104 to enable folding and unfolding of the exterior rearview mirror. The rotatable member 106 may be made up of, but not limited to, PA-GF50 material. As shown in FIG. 3, the rotatable member 106 may have a protruding member 106a. The protruding member 106a may be an extended arm of the rotatable member 106. The protruding member 106a may be configured to rotate along with the rotation of the rotatable member 106. The protruding member 106a may form a fixed path of rotation around the rotatable member 106.

The stopper 108 may be a physical barrier provided by the restriction element and configured to restrict the rotatable member 106 to pre-determined rotation. The stopper 108 may be mounted on the housing 104 such that the stopper 108 comes in the path of rotation of the protruding member 106a. The stopper 108 may be made up of, but not limited to, an alloy material. In an embodiment, the stopper may be made of diecast AL material.

As shown in FIGS. 2-4, the dampening member 110 may be configured to surround at least a portion of the stopper 108. The dampening member 110 may surround the portion of the stopper 108 such that the dampening member 110 may engage with the protruding member 106a of the rotatable member 106 for restricting the rotatable member 106 to the pre-determined rotation.

In an embodiment, the dampening member 110 may comprise of a second plastic member 110a and a third plastic member 110b. The second plastic member 110a may be configured to surround at least a portion of the stopper 108 such that the second plastic member 110a may engage with the protruding member 106a of the rotatable member 106 for restricting the rotatable member 106 to the pre-determined rotation. Furthermore, the third plastic member 110b may be configured to sandwich between the stopper 108 and the second plastic member 110a. The third plastic member 110b may be made up of, but not limited to, TPE Shore A60 material. In an embodiment, the third plastic member 110b may extend along a portion of the first plastic member 112.

In an embodiment, the first plastic member 112 and the second plastic member 110a may be made up of the same material. In yet another embodiment, the first plastic member 112 and the second plastic member 110a may be made up of the same material such that the second plastic member 110a is an extended surface of the first plastic member 112 to form a unitary plastic body. In yet another embodiment, the first plastic member 112 and the second plastic member 110a may be made up of different materials.

Further, the third plastic member 110b may be softer than the first plastic member 112 and the second plastic member 110a. Further, the housing 104, the stopper 108, the first plastic member 112, the second plastic member 110a and the third plastic member 110b may be static members.

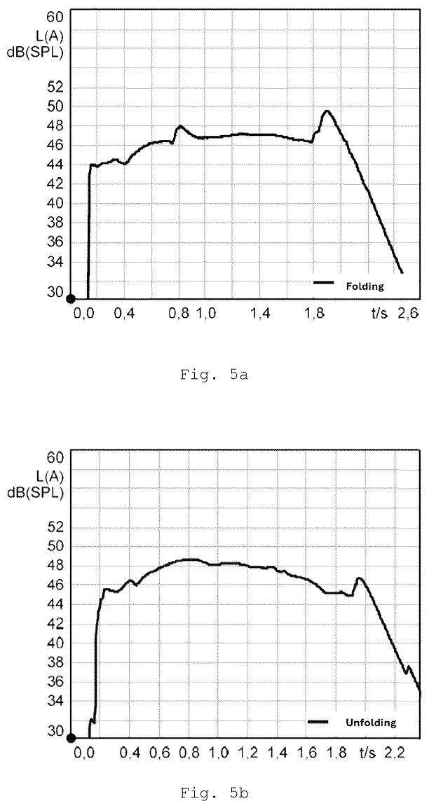

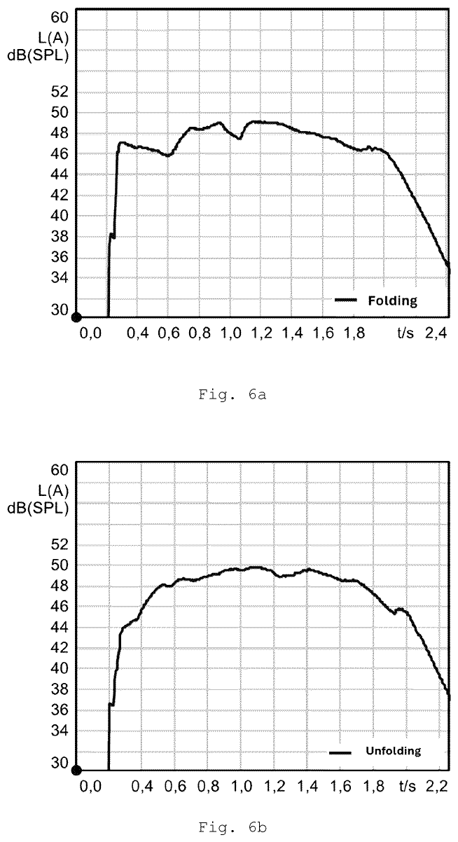

FIG. 5a shows experimental representation of noise-time graph for an existing exterior rearview mirror assembly without any dampening member for folding operation. Further, FIG. 5b shows experimental representation of noise-time graph for an existing exterior rearview mirror assembly without any dampening member for unfolding operation. FIG. 6a. shows experimental representation of noise-time graph in accordance with an embodiment of the present disclosure for folding operation. Further, FIG. 6b shows experimental representation of noise-time graph in accordance with an embodiment of the present disclosure for unfolding operation. FIGS. 6a-6b clearly show a decrease in noise levels as indicated by shifting downwards of kinks for both folding and unfolding operation.

Embodiment 1: An exterior rearview mirror assembly 100 for a vehicle 200, the exterior rearview mirror assembly 100 comprising: a housing 104; a rotatable member 106 rotatably mounted on the housing 104, wherein the rotatable member 106 is configured to mount an exterior rearview mirror; a restriction element comprising a stopper 108 configured on the housing 104; and a dampening member 110 comprised by the restriction element and configured to surround at least a portion of the stopper 108, wherein the dampening member 110 is configured to engage with the rotatable member 106 for restricting the rotatable member 106 to a pre-determined rotation.

Embodiment 2: The exterior rearview mirror assembly 100 also comprises a first plastic member 112, wherein the first plastic member 112 is configured for capping the housing 104.

Embodiment 3: The dampening member 110 comprises a second plastic member 110a and a third plastic member 110b, wherein the second plastic member 110a configured to surround at least a portion of the stopper 108, and the third plastic member 110b configured to sandwich between the stopper 108 and the second plastic member 110a.

Embodiment 4: The stopper 108 is made up of an alloy material.

Embodiment 5: The rotatable member 106 is made up of PAG50 material.

Embodiment 6: The first plastic member 112 and the second plastic member 110a are made up of same material.

Embodiment 7: The third plastic member 110b is softer than the first plastic member 112 and the second plastic member 110a.

Embodiment 8: The first plastic member 112 and the second plastic member 110a is a unitary plastic body.

Embodiment 9: The first plastic member 112 is made up of PPGF30 material.

Embodiment 10: The third plastic member 110b is made up of TPE Shore A60 material.

Embodiment 11: The second plastic member 110a is an extended surface of the first plastic member 112.

Embodiment 12: The housing 104, the stopper 108, the first plastic member 112, the second plastic member 110a and the third plastic member 110b are static members.

Embodiment 13: The third plastic member 110b extends along a portion of the first plastic member 112.

Embodiment 14: The rotatable member 106 comprises a protruding member 106a, wherein the protruding member 106a is configured to engage with the dampening member 110 on the stopper 108.

Embodiment 15: A vehicle 200 with an exterior rearview mirror assembly 100 according to any of preceding embodiments.

Therefore, there is a need to develop an exterior rearview mirror assembly for a vehicle which reduces noise production on collision of a rotatable member with a stopper.

Although the subject matter of the present disclosure has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims, i.e. the features disclosed in the foregoing description, the claims, and the drawings may be essential, both individually and in any combination, for accomplishing the present disclosure in its various embodiments. The embodiments shown herein are only examples of the present disclosure and must therefore not be understood as being restrictive. Alternative embodiments considered by the skilled person are equally covered by the scope of protection of the present disclosure.

### REFERENCE SIGN LIST

100 Exterior rearview mirror assembly
104 Housing
106 Rotatable member
106a Protruding member
108 Stopper
110 Dampening member
110a Second plastic member
110b Third plastic member
112 First plastic member
200 Vehicle

1. An exterior rearview mirror assembly for a vehicle, the exterior rearview mirror assembly comprising:
a housing;
a rotatable member rotatably connected at least indirectly to the housing, wherein the a rotatable member is configured to mount at least one exterior rearview mirror and/or camera;
a restriction element arranged on the housing and configured to restrict the rotatable member to a pre-determined rotation,
wherein the restriction element is configured as a two component element comprising a stopper and a dampening member, wherein the dampening member is configured to engage with the rotatable member when contacting the restriction element.

2. The exterior rearview mirror assembly according to claim 1, wherein the damping member is at least partly attached directly or indirectly to the stopper.

3. The exterior rearview mirror assembly according to claim 1, wherein the damping member is configured to surround at least a portion of the stopper.

4. The exterior rearview mirror assembly according to claim 1, wherein the damping member has a higher elasticity and/or is softer compared the stopper.

5. The exterior rearview mirror assembly according to claim 1, wherein the assembly further comprises a first plastic member, wherein the first plastic member is configured to cover at least a portion of the housing, and wherein the dampening member comprises a second plastic member.

6. The exterior rearview mirror assembly according to claim 5, wherein the dampening member further comprises a third plastic member, and wherein the third plastic member is configured to be positioned between the stopper and the second plastic member.

7. The exterior rearview mirror assembly of claim 6, wherein the third plastic member is configured to surround at least a portion of the stopper.

8. The exterior rearview mirror assembly according to claim 5, wherein the first plastic member and the second plastic member include the same material.

9. The exterior rearview mirror assembly according to claim 6, wherein the third plastic member has a higher elasticity and/or is softer than the first plastic member and/or the second plastic member.

10. The exterior rearview mirror assembly according to claim 5, wherein the first plastic member and the second plastic member at least partially form a unitary plastic body.

11. The exterior rearview mirror assembly according to claim 5, wherein the second plastic member is at least partly an extended surface of the first plastic member.

12. The exterior rearview mirror assembly according to claim 6, wherein at least one of the housing, the stopper, the first plastic member, the second plastic member, or the third plastic member is a fixed member.

13. The exterior rearview mirror assembly according to claim 6, wherein the third plastic member extends at least partly along a portion of the first plastic member.

14. The exterior rearview mirror assembly of claim 13, wherein the portion is substantially flat.

15. The exterior rearview mirror assembly according to claim 1, wherein the rotatable member comprises a protruding member.

16. The exterior rearview mirror assembly according to claim 15, wherein the protruding member is configured to engage at least partly with the dampening member on the stopper in order to provide a dampening of a rotating movement of the rotatable member.

17. A vehicle with at least one exterior rearview mirror assembly according to claim 1.

18. An exterior rearview mirror assembly for a vehicle, the exterior rearview mirror assembly comprising:
a housing;
a rotatable member rotatably connected at least indirectly to the housing, wherein the rotatable member is configured to mount at least one exterior rearview mirror and/or camera; and
a restriction element arranged on the housing and configured to restrict the rotatable member to a pre-determined rotation,
wherein the restriction element is configured as a two component element comprising a stopper and a dampening member,
wherein the dampening member is configured to engage with the rotatable member when contacting the restriction element,
wherein dampening member comprises a second plastic member and a third plastic member,
wherein the third plastic member has a higher elasticity and/or is softer than the second plastic member,
wherein the third plastic member is configured to be sandwiched between the stopper and the second plastic member, and/or the third plastic member is configured to surround at least a portion of the stopper.
